(19) United States
(12) Patent Application Publication
(10) Pub. No.: US 2022/0063520 A1
(43) Pub. Date: Mar. 3, 2022

(54) AUTONOMOUS VEHICLE

(71) Applicant: TOYOTA JIDOSHA KABUSHIKI KAISHA, Aichi-ken (JP)

(72) Inventors: Mitsuyoshi OHNO, Miyoshi-shi (JP); Kenta WATANABE, Saijo-shi (JP)

(21) Appl. No.: 17/346,298

(22) Filed: Jun. 14, 2021

(30) Foreign Application Priority Data
Sep. 2, 2020 (JP) 2020-147709

(51) Int. Cl. B60R 13/08; G05D 1/00; B60W 60/00; B60N 2/00; B60R 11/04; B60J 3/04

(52) U.S. Cl. CPC B60R 13/0823; G05D 1/0061; B60W 60/005; B60R 2011/0003; B60R 11/04; B60J 3/04; B60N 2/002

(57) ABSTRACT

A vehicle is switchable between autonomous driving and human driving, and includes a partition setting permission device. The partition setting permission device is set to permit setting of a partition that is a visual partition between occupants when the vehicle is autonomously driving. That is, the partition setting permission device does not operate during human driving. Therefore, when the vehicle is operated by human driving, a field of view is not obstructed by the partition. On the other hand, when the vehicle is autonomously driving, providing the partition makes it possible to secure a private space.

### CROSS-REFERENCE TO RELATED APPLICATION

This application claims priority to Japanese Patent Application No. 2020-147709 filed on Sep. 2, 2020, incorporated herein by reference in its entirety.

### BACKGROUND

### 1. Technical Field

The disclosure relates to an autonomous vehicle.

### 2. Description of Related Art

Japanese Unexamined Patent Application Publication No. 2019-127064 (JP 2019-127064 A) discloses a technique in which occupant seats of a ride-sharing vehicle are separated by partition walls. In the prior art, the partition walls partition a space in a vehicle cabin such that two private rooms are provided in each of a front row and a rear row, whereby privacy can be ensured.

### SUMMARY

However, in the case of the prior art above, when human driving is applied to the vehicle, the partition walls provided in the vehicle cabin makes it difficult to drive because the partition walls obstruct the field of view of a driver and the driver thus cannot see surroundings of the vehicle.

In consideration of the above fact, it is an object of the disclosure to provide an autonomous vehicle in which autonomous driving and human driving can be switched, a visibility is not obstructed during human driving, and private spaces can be secured during autonomous driving.

An autonomous vehicle according to claim 1 is switchable between autonomous driving and human driving, and includes a partition setting permission device that permits setting of a visual partition between occupants during the autonomous driving.

The autonomous vehicle according to claim 1 is switchable between autonomous driving and human driving, and includes the partition setting permission device. The partition setting permission device is set to permit setting of a visual partition between the occupants during autonomous driving. That is, the partition setting permission device does not operate during human driving.

In other words, in the disclosure, the visual partition is not set while the autonomous vehicle is operated by human driving. Therefore, when the autonomous vehicle is operated by human driving, a field of view is not obstructed by the partition. On the other hand, when the autonomous vehicle is autonomously driving, providing the visual partition makes it possible to secure a private space.

Here, the “visual partition” means a partition that obstructs the field of view. Therefore, for example, a glass that is colorless and transparent and simply partitions a space although the glass is provided with a light-controlling function does not correspond to the “visual partition” herein.

In the autonomous vehicle according to claim 2, in the autonomous vehicle according to claim 1, the partition is light-controllable.

In the autonomous vehicle according to claim 2, for example, a light control member such as a light control glass or a light control sheet are exemplified as a light-controllable partition. The transparency of the light control member can be changed, for example. When the light control member is transparent, the light control member does not correspond to the visual partition. Therefore, the private space cannot be secured. On the other hand, the light control member can obstruct the field of view when the transparency is reduced because a light-shielding property becomes higher. In this case, the private space can be secured by the light control member.

In the autonomous vehicle according to claim 3, in the autonomous vehicle according to claim 1 or 2, after the partition setting permission device permits setting of the partition, whether to set the partition automatically or manually is selectable.

In the autonomous vehicle according to claim 3, after the partition setting permission device permits setting of the partition, whether to set the partition automatically or manually is selectable, which makes it possible to set the partition in accordance with the needs of the occupants during autonomous driving of the vehicle.

The autonomous vehicle according to claim 4 includes, in the autonomous vehicle according to any one of claims 1 to 3, a housing portion that houses the partition when the partition setting permission device does not permit setting of the partition.

In the autonomous vehicle according to claim 4, the housing portion that houses the partition is provided. When the partition setting permission device does not permit setting of the partition, a state where the partition is housed in the housing portion is maintained. That is, the partition is not exposed in the vehicle cabin even though the partition is not set.

In the autonomous vehicle according to claim 5, in the autonomous vehicle according to any one of claims 1 to 4, a seating position of the occupant who is seated on a vehicle seat is detectable using an in-vehicle photographing camera or a seating sensor, and when the occupants are seated next to each other in at least a vehicle width direction or a vehicle front-rear direction, the partition is set between the occupants who are seated next to each other.

In the autonomous vehicle according to claim 5, the seating position of the occupant is detected using the in-vehicle photographing camera or the seating sensor. For example, when there is no occupant who is seated side by side in the vehicle width direction, the private space is wide enough including the adjacent space. Therefore, there is no need to intentionally set the partition in this case. Accordingly, in the disclosure, when there are occupants who are seated side by side in at least the vehicle width direction or the vehicle front-rear direction, the partition is set between the occupants who are seated side by side. That is, in the disclosure, it is possible to set the partition as needed.

As described above, the autonomous vehicle according to claim 1 has an excellent effect in which the autonomous vehicle is switchable between autonomous driving and human driving, and the field of view is not obstructed during human driving and the private space can be secured during autonomous driving.

The autonomous vehicle according to claim 2 has an excellent effect in which a degree of shielding can be adjusted in accordance with the needs for shielding of the occupants.

The autonomous vehicle according to claim 3 has an excellent effect in which setting of the partition can be selected in accordance with the needs of the occupants during autonomous driving.

The autonomous vehicle according to claim 4 has an excellent effect in which the driver can drive the vehicle without obstructing the field of view of the driver by the partition during human driving, because the partition is housed when the partition setting permission device does not permit setting of the partition.

The autonomous vehicle according to claim 5 has an excellent effect in which the space for the occupant can be suppressed from being unnecessarily narrowed even when the seat next to the occupant is vacant.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a sectional view of a vehicle cabin of an autonomous vehicle according to an embodiment when the vehicle cabin is cut along a vehicle width direction and a vehicle up-down direction and viewed from a front side of the vehicle;

FIG. 2 is a block diagram showing a hardware configuration of a partition setting permission device provided in the autonomous vehicle according to the embodiment;

FIG. 3 is a block diagram showing a functional configuration of the partition setting permission device provided in the autonomous vehicle according to the embodiment;

FIG. 4 is a flowchart showing an example of a flow of an extension process of a partition provided in the autonomous vehicle according to the embodiment;

FIG. 5A is a diagram showing a second modification of the partition provided in the autonomous vehicle according to the embodiment, and is an enlarged sectional view of a main portion showing a state in which the partition is housed;

FIG. 5B is a diagram showing the second modification of the partition provided in the autonomous vehicle according to the embodiment, and is an enlarged sectional view of the main portion showing a state in which the partition is extended;

FIG. 6 is a perspective view showing a state in which the partition is extended, showing a third modification of the partition provided in the autonomous vehicle according to the embodiment;

FIG. 7 is a sectional view corresponding to FIG. 1 showing the third modification of the partition provided in the autonomous vehicle according to the embodiment;

FIG. 8 is a perspective view showing a fourth modification of the partition provided in the autonomous vehicle according to the embodiment; and

FIG. 9 is a perspective view corresponding to FIG. 8 showing the fourth modification of the partition provided in the autonomous vehicle according to the embodiment.

### DETAILED DESCRIPTION OF EMBODIMENTS

An autonomous vehicle (hereinafter, simply referred to as a “vehicle”) 10 according to an embodiment of the disclosure will be described with reference to the drawings. The vehicle 10 according to the present embodiment is configured to be switchable between autonomous driving and human driving.

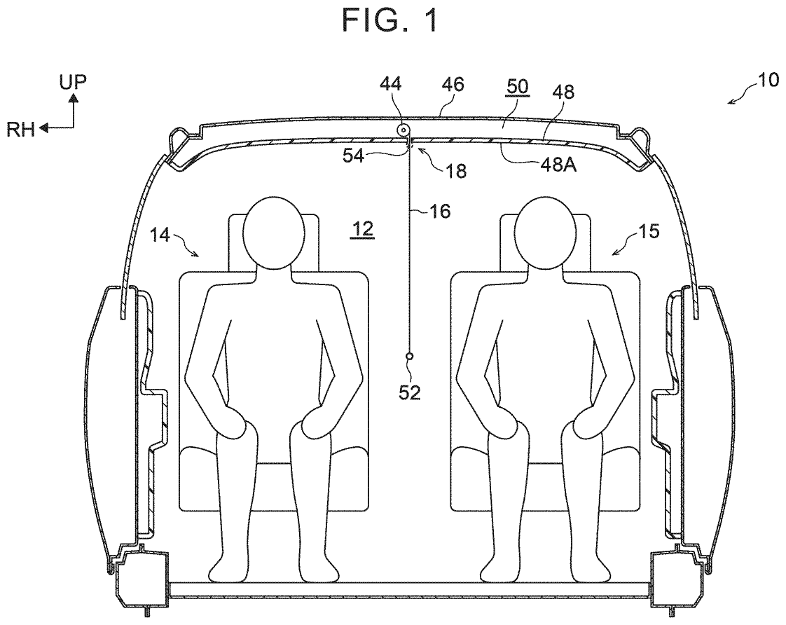

FIG. 1 shows a sectional view of a vehicle cabin 12 of the vehicle 10 according to the present embodiment when the vehicle cabin 12 is cut along a vehicle width direction and a vehicle up-down direction and viewed from a front side of the vehicle. As shown in FIG. 1, the vehicle 10 of the present embodiment includes, in the vehicle cabin 12, vehicle seats 14, 15 disposed adjacent to each other (side by side) along the vehicle width direction and a partition setting permission device 18 that permits setting of a visual partition 16 that obstructs fields of view of occupants who are seated on the vehicle seats 14, 15 between the occupants such that a private space for each occupant can be secured. The partition setting permission device 18 permits, during autonomous driving of the vehicle 10, setting of the partition 16 between the occupants such that the private spaces for the occupants can be secured, and whether to permit the setting is selectable. That is, the partition setting permission device 18 does not operate during human driving. Hardware Configuration of Partition Setting Permission Device 18

Here, a hardware configuration of the partition setting permission device 18 will be described.

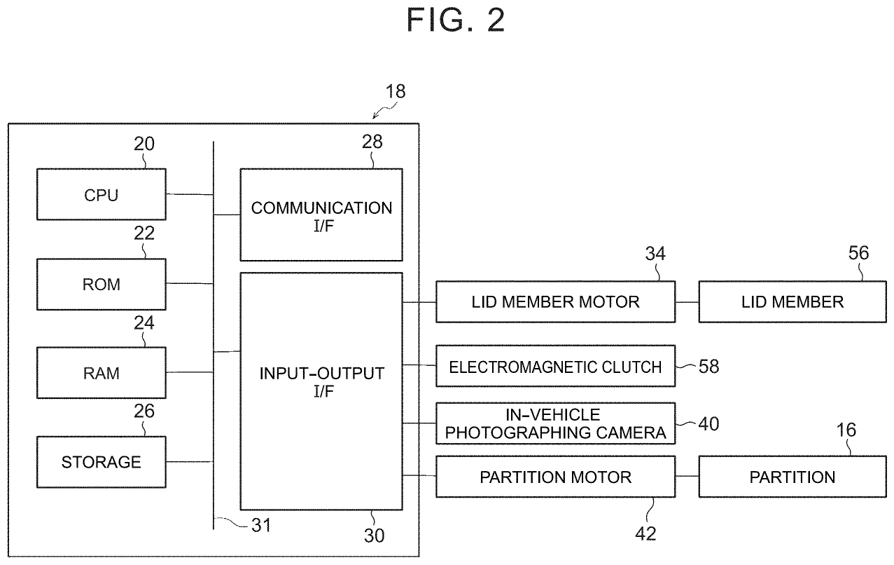

FIG. 2 is a block diagram showing the hardware configuration of the partition setting permission device 18. As shown in FIG. 2, the partition setting permission device 18 is configured to include a central processing unit (CPU: processor) 20, a read-only memory (ROM) 22, a random access memory (RAM) 24, a storage 26, a communication interface (communication I/F) 28, and an input-output interface (input-output I/F) 30. The components above are connected via a bus 31 so as to be mutually communicable.

The CPU 20 is a central arithmetic processing unit that executes various programs and controls each unit. That is, the CPU 20 reads the program from the ROM 22 or the storage 26, and executes the program using the RAM 24 as a work area. The CPU 20 controls each of the above components and performs various arithmetic processes in accordance with the programs stored in the ROM 22 or the storage 26.

The ROM 22 stores various programs and various data. The RAM 24 temporarily stores a program or data as a work area. The storage 26 is composed of a hard disk drive (HDD) or a solid state drive (SSD), and stores various programs including an operating system, and various data. In the present embodiment, the ROM 22 or the storage 26 stores a program for performing a display process and various data, etc.

The communication I/F 28 is an interface for performing communication with a server and other devices (not shown), and standards such as Ethernet (registered trademark), long-term evolution (LTE), fiber-distributed data interface (FDDI), and Wi-Fi (registered trademark) are used.

A lid member motor 34, an electromagnetic clutch 58, an in-vehicle photographing camera 40, and a partition motor 42 are each connected to the input-output I/F 30.

As shown in FIG. 1, the partition 16 is made of a flexible material and can be rolled around a columnar core 44. The partition 16 can be housed in a ceiling space (hereinafter referred to as a “housing portion”) 50 defined between a roof panel 46 and a ceiling member 48 constituting an upper surface of the vehicle cabin 12 in the vehicle 10 in a state where the partition 16 is rolled around the core 44. Further, a mass 52 is provided at a tip of the partition 16 such that the extended partition 16 can be maintained in a hanging state.

On the other hand, the ceiling member 48 is provided with an opening 54 through which the partition 16 can pass. The opening 54 is provided so as to be disposed between the occupants when viewed in a plan view.

Here, a lid member 56 is provided so as to be openable and closable with respect to the opening 54, and is slidable along a ceiling surface 48A.

The lid member motor 34 is capable of making both forward and reverse rotations, and is connected to the lid member 56. For example, although not shown, a pinion is connected to the lid member motor 34 such that the lid member 56 is slidably moved along the ceiling surface 48A via the pinion and a rack.

With the configuration above, the opening 54 opens and closes. When the opening 54 is opened as the lid member 56 is slidably moved, the housing portion 50 and the vehicle cabin 12 communicate with each other. In the state where the partition 16 is rolled around the core 44 and stored in the housing portion 50, the opening 54 is closed by the lid member 56.

The electromagnetic clutch 58 is disposed between the core 44 (see FIG. 1) and the partition motor 42. Connection and disconnection between the core 44 and the partition motor 42 can be switched via the electromagnetic clutch 58.

For example, when the electromagnetic clutch 58 is turned on, the core 44 and the partition motor 42 are connected, and a driving force of the partition motor 42 is transferred to the core 44. On the other hand, when the electromagnetic clutch 58 is turned off, the core 44 and the partition motor 42 are disconnected, and the driving force of the partition motor 42 is not transferred to the core 44. That is, the core 44 can idle.

The in-vehicle photographing camera 40 is provided in the vehicle cabin 12 (see FIG. 1). As shown in FIG. 1, the in-vehicle photographing camera 40 captures an image of the inside the vehicle cabin 12 such that seating positions (vehicle seats 14, 15) of the occupants who are seated can be identified. Note that, a seating sensor may be used in place of the in-vehicle photographing camera 40 as long as the seating position of the occupant who is seated can be identified.

The partition motor 42 can be connected to the core 44 around which the partition 16 is rolled. In the state where the partition motor 42 is connected to the core 44, the partition motor 42 is driven to rotate the core 44. The target partition motor 42 is driven based on a result detected from the image captured by the in-vehicle photographing camera 40. Note that, a plurality of the partition motors 42 and a plurality of the partitions 16 may be provided. The partition 16 is placed between the occupants who are seated next to each other by the partition motor 42.

Further, in the present embodiment, as described above, the electromagnetic clutch 58 is provided between the core 44 and the partition motor 42. Connection and disconnection between the core 44 and the partition motor 42 can be switched via the electromagnetic clutch 58. Therefore, when the electromagnetic clutch 58 is turned on, the core 44 and the partition motor 42 are connected to each other. Therefore, the partition 16 is automatically extended or housed by the driving force of the partition motor 42.

On the other hand, when the electromagnetic clutch 58 is turned off, the core 44 and the partition motor 42 are disconnected. Therefore, the partition 16 is manually extended. Here, for example, the core 44 is provided with a spring, although not shown. The spring is set such that, when the partition 16 is extended, elastic energy is accumulated in the spring. The partition 16 can be locked at a predetermined position. When the lock is released, the partition 16 is automatically rolled around the core 44 (housed) by releasing the elastic energy (a restoring force of the spring). Functional Configuration of Partition Setting Permission Device 18

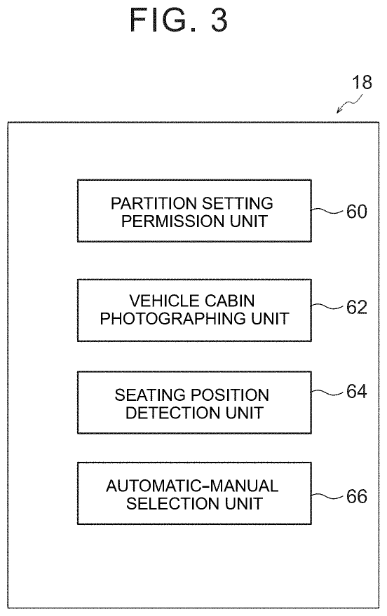

The partition setting permission device 18 realizes various functions using hardware resources above. The functional configuration realized by the partition setting permission device 18 will be described with reference to FIG. 3.

As shown in FIG. 3, the partition setting permission device 18 is configured to include a partition setting permission unit 60, a vehicle cabin photographing unit 62, a seating position detection unit 64, and an automatic-manual selection unit 66 as a functional configuration. Each unit in the functional configuration is realized by the CPU 20 shown in FIG. 2 as the CPU 20 reads and executes the program stored in the ROM 22 or the storage 26.

As described above, during autonomous driving of the vehicle 10 (see FIG. 1), the partition setting permission unit 60 permits setting of the partition 16 that can secure the private spaces of the occupants who are seated next to each other between the occupants, and whether to set the partition 16 can be selected. Therefore, when the partition setting permission unit 60 permits setting of the partition 16, the lid member motor 34 is driven. With the configuration above, the lid member 56 slides to open the opening 54 (see FIG. 1), and the partition 16 can be used.

The vehicle cabin photographing unit 62 captures an image of the inside of the vehicle cabin 12 using the in-vehicle photographing camera 40.

The seating position detection unit 64 detects the positions of the occupants who are seated in the vehicle cabin 12 based on the image captured by the in-vehicle photographing camera 40. In the present embodiment, when the occupants are seated on the respective vehicle seats 14, 15 that are adjacent to each other, the partition 16 can be placed between the vehicle seat 14 and the vehicle seat 15.

The automatic-manual selection unit 66 makes it possible to select whether to automatically extend or manually extend the partition 16. Further, as described above, the electromagnetic clutch 58 is provided between the core 44 (see FIG. 1) and the partition motor 42. Connection and disconnection between the core 44 and the partition motor 42 can be switched via the electromagnetic clutch 58.

For example, when the electromagnetic clutch 58 is turned on, the core 44 and the partition motor 42 are connected, and a driving force of the partition motor 42 is transferred to the core 44. On the other hand, when the electromagnetic clutch 58 is turned off, the core 44 and the partition motor 42 are disconnected, and the driving force of the partition motor 42 is not transferred to the core 44. That is, the core 44 can idle.

Therefore, when automatic extension is selected by the automatic-manual selection unit 66, the electromagnetic clutch 58 is turned on, which transfers the driving force of the partition motor 42 to the core 44. Therefore, the partition motor 42 is driven to extend the partition 16 into the vehicle cabin 12 through the opening 54 in a state where the opening 54 is opened as the lid member 56 is slidably moved.

On the other hand, when manual extension is selected by the automatic-manual selection unit 66, the electromagnetic clutch 58 is turned off, which does not transfer the driving force of the partition motor 42 to the core 44. As a result, the core 44 can idle. Therefore, the occupant can extend the partition 16 into the vehicle cabin 12 through the opening 54 in a state where the opening 54 is opened as the lid member 56 is slidably moved. Action and Effect of Partition Setting Permission Device 18

Next, actions and effects of the partition setting permission device 18 according to the present embodiment will be described.

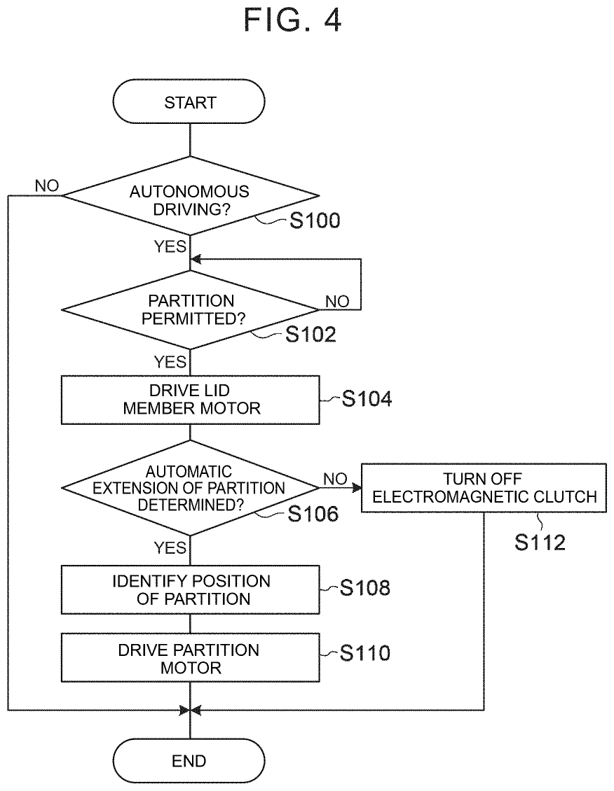

An extension process of the partition 16 shown in FIG. 2 will be described with reference to the flowchart shown in FIG. 4. The extension process is executed by the CPU 20 shown in FIG. 2 in a manner such that the CPU 20 reads the display program from the ROM 22 or the storage 26, decompresses the read program into the RAM 24, and executes the program.

As shown in FIG. 4, the CPU 20 determines in step S100 whether the vehicle 10 (see FIG. 1) is autonomously driving.

When the CPU 20 determines in step S100 that the vehicle 10 is autonomously driving (step S100: Y), the CPU 20 proceeds to the process in step S102.

Further, when the CPU 20 determines in step S100 that the vehicle 10 is not autonomously driving (step S100: N), the CPU 20 terminates the routine. That is, the partition 16 is not extended into the vehicle cabin 12.

Next, in step S102, the CPU 20 determines whether to permit use of the partition 16 by the partition setting permission device 18.

When the CPU 20 determines in step S102 that the use of the partition 16 is permitted (step S102: Y), the CPU 20 proceeds to the process in step S104. In step S102, the process is executed until the CPU 20 determines that the use of the partition 16 is permitted.

The CPU 20 drives the lid member motor 34 in step S104. With the process above, the lid member 56 slides to open the opening 54.

Next, in step S106, the CPU 20 determines whether to automatically extend the partition 16. When the CPU 20 determines in step S106 that the partition 16 is automatically extended (step S106: Y), the CPU 20 proceeds to the process in step S108.

Next, in step S108, the CPU 20 detects the positions of the occupants who are seated in the vehicle cabin 12 based on the image captured by the in-vehicle photographing camera 40 so as to identify the position of the partition 16 to be extended.

Subsequently, in step S110, the CPU 20 drives the partition motor 42 that extends the partition 16. With the process above, the partition 16 is extended into the vehicle cabin 12 and is placed between the occupants who are seated next to each other.

On the other hand, when the CPU 20 determines in step S106 that the partition 16 is manually extended (step S106: N), the CPU 20 proceeds to the process in step 5112.

Subsequently, in step S112, the CPU 20 turns off the electromagnetic clutch 58. With the process above, the core 44 and the partition motor 42 are disconnected. Therefore, the partition 16 can be manually extended.

As described above, in the present embodiment, the vehicle 10 shown in FIG. 1 can be switched between autonomous driving and human driving, and the vehicle 10 is provided with the partition setting permission device 18. The partition setting permission device 18 is set to permit setting of the partition 16 that is a visual partition between the occupants when the vehicle 10 is autonomously driving. That is, the partition setting permission device 18 does not operate during human driving.

In other words, in the present embodiment, the partition 16 is not set while the vehicle 10 is operated by human driving. Therefore, when the vehicle 10 is operated by human driving, the field of view is not obstructed by the partition 16. On the other hand, when the vehicle 10 is autonomously driving, providing the partition 16 makes it possible to secure the private space.

Further, in the present embodiment, after setting of the partition 16 is permitted by the partition setting permission device 18, whether to set the partition 16 automatically or manually can be selected. That is, in the present embodiment, when the vehicle 10 is autonomously driving, the setting of the partition 16 can be selected in accordance with the needs of the occupants.

Further, in the present embodiment, the housing portion 50 that houses the partition 16 is provided. When the partition setting permission device 18 does not permit setting of the partition 16, the partition 16 is housed in the housing portion 50. That is, the partition 16 is not exposed to the vehicle cabin 12 even though the partition 16 is not set, and the driver can operate the vehicle 10 without the partition 16 obstructing the field of view during human driving of the vehicle 10.

Furthermore, in the present embodiment, the in-vehicle photographing camera 40 captures the image of the inside of the vehicle cabin 12, and the seating position detection unit 64 detects the position of the occupant who is seated in the vehicle cabin 12 based on the captured image. When the occupants are respectively seated on at least the vehicle seats 14, 15 that are adjacent to each other along the vehicle width direction, the partition 16 can be placed between the vehicle seat 14 and the vehicle seat 15.

That is, when there is no occupant next to the occupant who is seated, the private space is wide enough including the adjacent space. Therefore, there is no need to intentionally set the partition in this case. Accordingly, in the present embodiment, the space surrounding the occupant can be suppressed from being unnecessarily narrowed even when the seat next to the seated occupant is vacant.

Here, the partition 16 can be placed between the vehicle seat 14 and the vehicle seat 15 that are adjacent to each other along the vehicle width direction. However, the disclosure is not limited to this. For example, although not shown, the partition 16 may be placed between the vehicle seats disposed side by side along a vehicle front-rear direction.

### Other Embodiments

As described above, in the present embodiment, the partition 16 shown in FIG. 1 is rolled around the columnar core 44, and the partition 16 is extended or rolled as the partition motor 42 rotates the core 44. However, the partition 16 is not necessarily rolled.

For example, as a first modification, the partition 16 may be housed in the housing portion 50 provided between the roof panel 46 and the ceiling member 48 in a state where the partition 16 is extended, although not shown. In this case, an outer peripheral surface of the core 44 comes into contact with a surface of the partition 16, and the partition 16 is fed out as the core 44 rotates due to a frictional force between the partition 16 and the core 44.

As shown in FIG. 1, when the partition 16 is rolled around the core 44, an outer diameter dimension becomes large, which requires the housing portion 50 to secure the corresponding dimension. However, according to the first modification, the partition 16 is not rolled around the core 44, and therefore, the dimension of the housing portion 50 in the vehicle up-down direction can be reduced, although not shown.

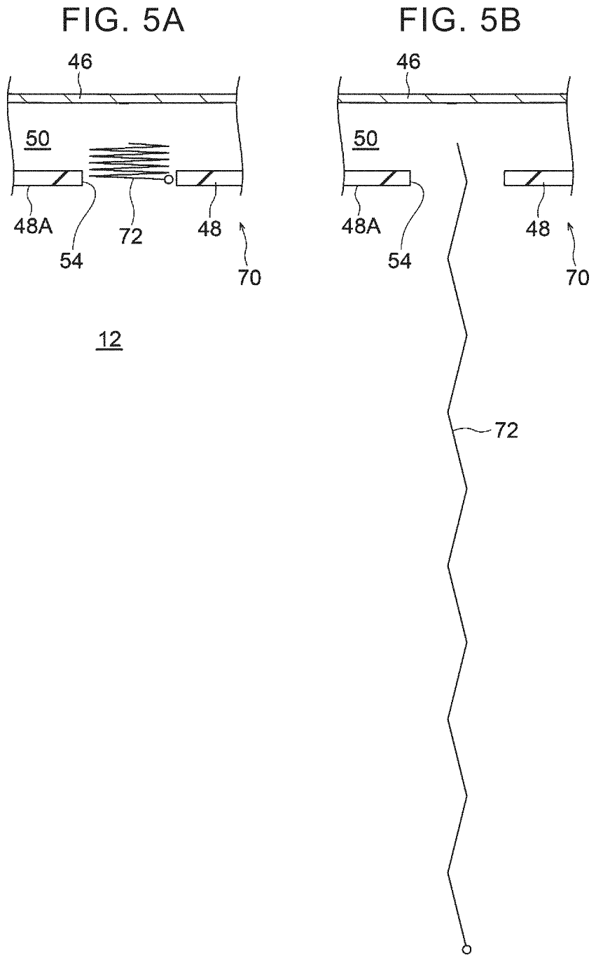

Further, as a second modification, a foldable partition 72 may be used in a partition setting permission device 70, as shown in FIGS. 5A and 5B. In this case as well, as in the case of the first modification, the dimension of the housing portion 50 in the vehicle up-down direction can be reduced, compared with the case where the partition 16 is rolled around the core 44 as shown in FIG. 1.

In the case of the second modification, a cord is wound around the partition 72 once over two surfaces of the partition 72 along an extension direction of the partition 72 in a state where the partition 72 is extended. The cord is wound by the partition motor 42. When the cord is wound by the partition motor 42, the cord moves upward, and the partition 72 is folded in accordance with the upward movement of the cord.

Further, in the above embodiment, as shown in FIG. 1, the partition 16 is housed in the housing portion 50, and the housing portion 50 is not exposed to the vehicle cabin 12. However, the disclosure is not limited to this.

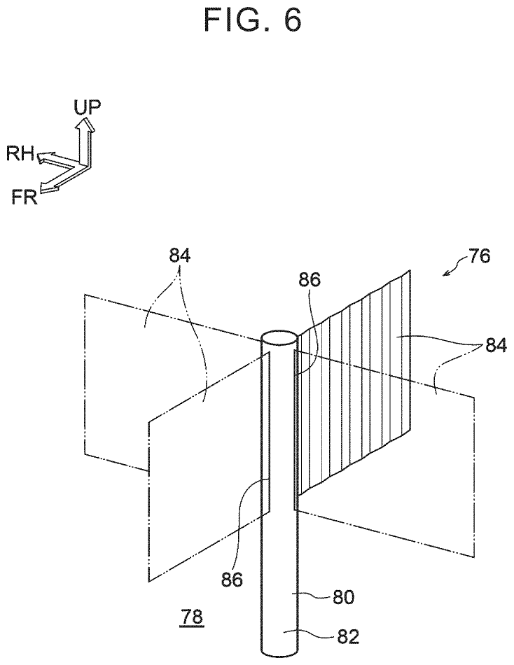

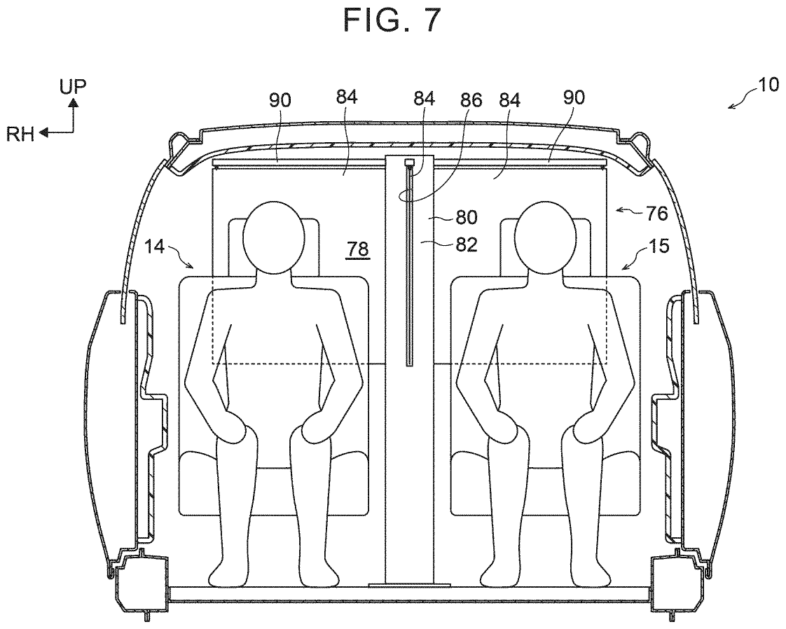

For example, as a third modification, in a partition setting permission device 76, a support pole 80 is provided in a vehicle cabin 78, as shown in FIGS. 6 and 7. The support pole 80 may be a housing portion 82. An opening 86 through which a partition 84 can pass is provided for the support pole 80, and the partition 84 is extended or housed through the opening 86.

In the case of the third modification, the partition 84 is extended along a substantially horizontal direction. Therefore, for example, rails 90 are disposed on a ceiling member 88 of the vehicle cabin 78 along the vehicle front-rear direction and the vehicle width direction. Although not shown, the rails 90 are each provided with a pulley and a belt. The belt is attached to a tip of the partition 84. When the partition motor 42 (see FIG. 2) provided corresponding to each rail 90 is driven, the belt moves via the pulley, which makes it possible to extend or house the partition 84 via the belt.

Here, the partition 84 is provided along the vehicle front-rear direction and the vehicle width direction. However, the disclosure is not limited to this, and the partition 84 may be provided along the vehicle front-rear direction or the vehicle width direction. Further, here, the rails 90 are disposed along the vehicle front-rear direction and the vehicle width direction. However, the rails 90 are changed in accordance with an arrangement of the vehicle seats 14, 15.

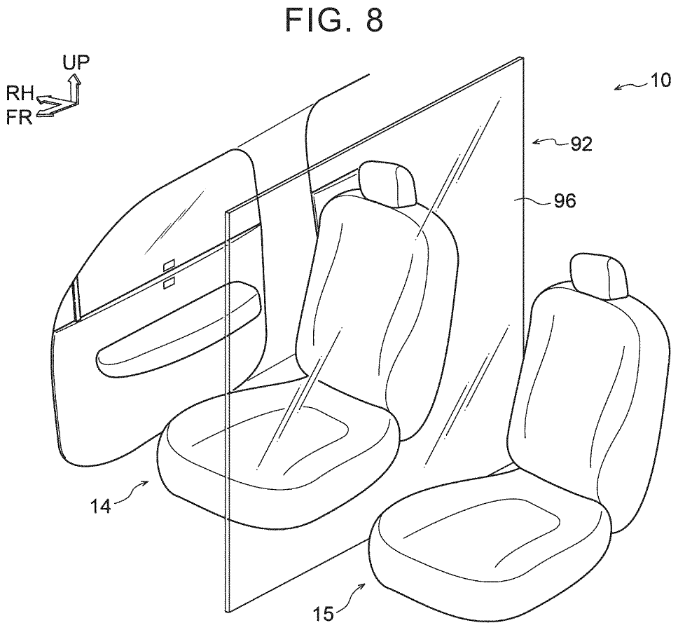

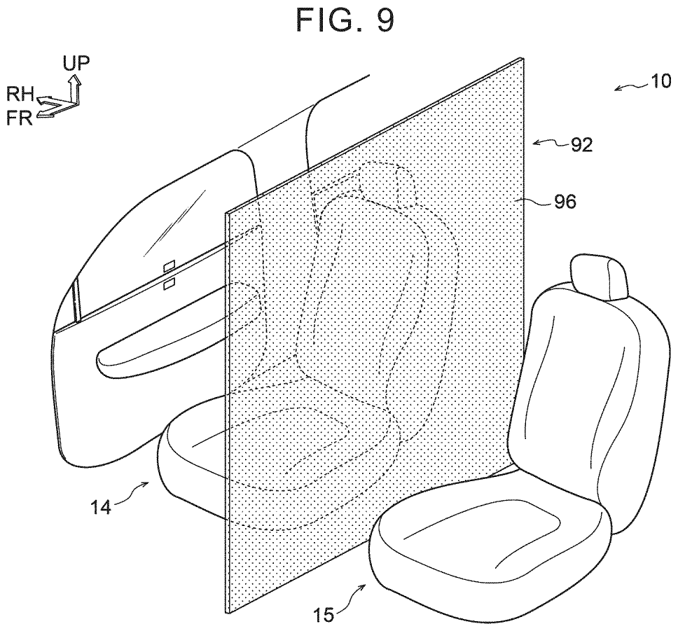

Further, as a fourth modification, in a partition setting permission device 92, a light control glass 96 may be provided in a vehicle cabin 94, as shown in FIGS. 8 and 9. The light control glass 96 can change a transparency. As shown in FIG. 8, when the transparency is high, the light control glass 96 does not correspond to a visual partition, and the occupant seated next to another occupant is visible through the light control glass 96. Therefore, the private space cannot be secured for both of the occupants.

On the other hand, as shown in FIG. 9, the light control glass 96 can obstruct the field of view when the transparency is reduced because a light-shielding property becomes higher. In other words, the occupant seated next to another occupant is not visible through the light control glass 96. Therefore, the private space can be secured for both of the occupants. As described above, in the present embodiment, a degree of shielding can be adjusted in accordance with the needs for shielding the occupants by means of light control.

Here, the light control glass 96 is used as a partition. Therefore, the light control glass 96 is permanently installed in the vehicle cabin. However, a member that can control light is not limited to the light control glass 96. For example, although not shown, a rollable screen-type light control film may be used.

Although the partition setting permission device according to the embodiment has been described above, the disclosure can be implemented in various modes without departing from the scope of the disclosure. For example, various processors other than the CPU 20 may execute the display process executed by the CPU 20 in a manner such that the CPU 20 reads and executes the software (program) in the above embodiment. As the processor in this case, a programmable logic device (PLD) of which circuit configuration can be changed after being manufactured, such as a field-programmable gate array (FPGA), and a dedicated electric circuit that is a processor including a circuit configuration that has been exclusively designed for executing a specific process, such as an application specific integrated circuit (ASIC), are exemplified. In addition, partition permission may be executed by one of the various processors, or a combination of two or more processors of the same type or different types (for example, a plurality of FPGAs, and a combination of a CPU and an FPGA) may execute the partition permission. Further, the hardware configuration of the various processors is, more specifically, an electric circuit in which circuit elements such as semiconductor devices are combined.

Further, in the above embodiment, the storage 26 is configured to store various data. However, the disclosure is not limited to this. For example, a recording medium such as a compact disk (CD), a digital versatile disk (DVD), or a universal serial bus (USB) memory may be used as a storage unit. In this case, various programs and data, etc. are stored in the recording medium exemplified above.

What is claimed is:

1. An autonomous vehicle, wherein the autonomous vehicle is switchable between autonomous driving and human driving, and includes a partition setting permission device that permits setting of a visual partition between occupants during the autonomous driving.

2. The autonomous vehicle according to claim 1, wherein the partition is light-controllable.

3. The autonomous vehicle according to claim 1, wherein after the partition setting permission device permits setting of the partition, whether to set the partition automatically or manually is selectable.

4. The autonomous vehicle according to claim 1, further comprising a housing portion that houses the partition when the partition setting permission device does not permit setting of the partition.

5. The autonomous vehicle according to claim 1, wherein a seating position of the occupant who is seated on a vehicle seat is detectable using an in-vehicle photographing camera or a seating sensor, and when the occupants are seated next to each other in at least a vehicle width direction or a vehicle front-rear direction, the partition is set between the occupants who are seated next to each other.
